(19) United States
(12) Patent Application Publication
(10) Pub. No.: US 2012/0136958 A1
(43) Pub. Date: May 31, 2012

(54) METHOD FOR ANALYZING PROTOCOL DATA UNIT OF INTERNET SMALL COMPUTER SYSTEMS INTERFACE

(75) Inventors: Ming-Sheng Zhu, Tianjin (CN); Chih-Feng Chen, Taipei (TW)

(73) Assignee: INVENTEC CORPORATION, Taipei (TW)

(21) Appl. No.: 13/073,571

(22) Filed: Mar. 28, 2011

(30) Foreign Application Priority Data
Nov. 30, 2010 (CN) 201010589581.9

(51) Int. Cl. G06F 15/167

(52) U.S. Cl. 709/212

(57) ABSTRACT

A method for analyzing a Protocol Data Unit (PDU) of an internet Small Computer Systems Interface (iSCSI) is used for processing a data write request of the iSCSI. The method includes sending the data write request to a target; the target generating a Ready to Transfer (R2T) PDU according to the data write request, and transferring the R2T PDU to an initiator; the initiator generating multiple groups of Data Out PDUs, and writing a scatter/gather block in a target transfer tag of each Data Out PDU; the target finding the corresponding scatter/gather block according to the target transfer tag, and obtaining a host buffer from the scatter/gather block; the target executing a Direct Memory Access command, so as to directly write a payload content received by the target in the host buffer; and after the target completes the write request, the target sending out an RSP PDU to the initiator.

### CROSS-REFERENCE TO RELATED APPLICATIONS

This non-provisional application claims priority under 35 U.S.C. §119(a) on Patent Application No(s). 201010589581.9 filed in China, P.R.C. on Nov. 30, 2010, the entire contents of which are hereby incorporated by reference.

### BACKGROUND OF THE INVENTION

1. Field of Invention

The present invention relates to a method for analyzing a Protocol Data Unit (PDU), and more particularly to a method for analyzing a PDU of an internet Small Computer Systems Interface (iSCSI).

2. Related Art

The iSCSI is a communication protocol standard proposed by the Internet Engineering Task Force (IETF). The iSCSI connects multiple computer hosts of a network through the Transmission Control Protocol/Internet Protocol (TCP/IP), so as to connect in series multiple storage devices 130 scattered in an internet into a virtual network storage device. A user accesses the network storage device, just like accessing a local hard disk device. Compared with the conventional Small Computer Systems Interface (SCSI) and Redundant Array of Independent Disks (RAID) technologies, the iSCSI technology has the high-speed transmission capability of the SCSI without being limited to the expansion/backup capability of a storage device, and thus the capacity of the virtual storage device can be expanded unlimitedly. The virtual storage device is referred to as a Storage Area Network (SAN), and mainly composed of an initiator 110 and a target 120. The initiator 110 transfers an access request and establishes a session with the target 120. Referring to FIG. 1, it is a schematic view of transferring an access request and a PDU in the prior art.

In the iSCSI protocol, a variety of formats for encapsulating a PDU are defined, but most of them are used for protocol management and error recovery. Formats really involved in data transmission of the iSCSI only include the formats such as a SCSI CMD PDU, a Data In PDU, a Data Out PDU, and a Ready to Transfer (R2T) PDU. However, much time is spent on the resolution of a PDU on each layer. Therefore, if the resolution processing of a PDU is accelerated, the overall access efficiency will be improved effectively.

### SUMMARY OF THE INVENTION

In view of the above problems, the present invention is a method for analyzing a PDU of an iSCSI, so as to process a data write request of the iSCSI.

The present invention provides a method for analyzing a PDU of an iSCSI, which comprises: establishing communication between an initiator and a target, and sending a data write request to the target; a segment reassemble engine of the target generating an R2T PDU according to the data write request; the target transferring the R2T PDU to the initiator; the initiator generating multiple groups of Data Out PDUs according to the R2T PDU, and writing a scatter/gather block in a target transfer tag of each Data Out PDU; transferring the Data Out PDU to the target; the target finding the corresponding scatter/gather block according to the target transfer tag, and obtaining a host buffer from the scatter/gather block; the target executing a Direct Memory Access (DMA) command, so as to directly write a payload content received by the target in the host buffer; and after the target completes the write request, the target sending out an RSP PDU to the initiator.

The present invention provides a method for analyzing a PDU of an iSCSI, so as to improve an access speed of the whole system in writing by adjusting a content of a data packet transferred by a target.

### BRIEF DESCRIPTION OF THE DRAWINGS

The present invention will become more fully understood from the detailed description given herein below for illustration only, and thus are not limitative of the present invention, and wherein:

FIG. 1 is a schematic view of transferring an access request and a PDU in the prior art;

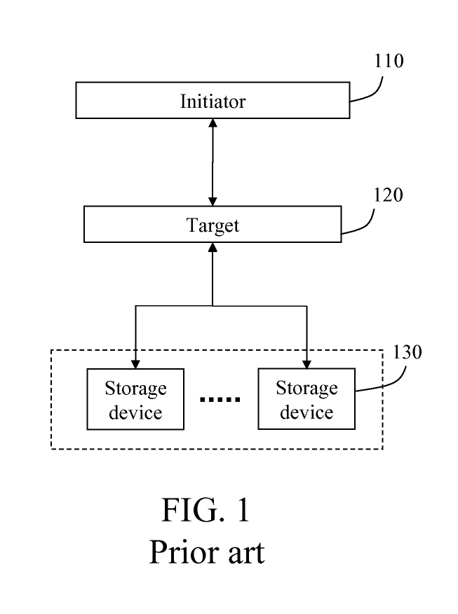

FIG. 2 is a schematic view of an architecture of the present invention;

FIG. 3 is a schematic flow chart of an operation of the present invention; and

FIG. 4 is a schematic view of an operation for looking up a scatter/gather list (sg list) in the present invention.

### DETAILED DESCRIPTION OF THE INVENTION

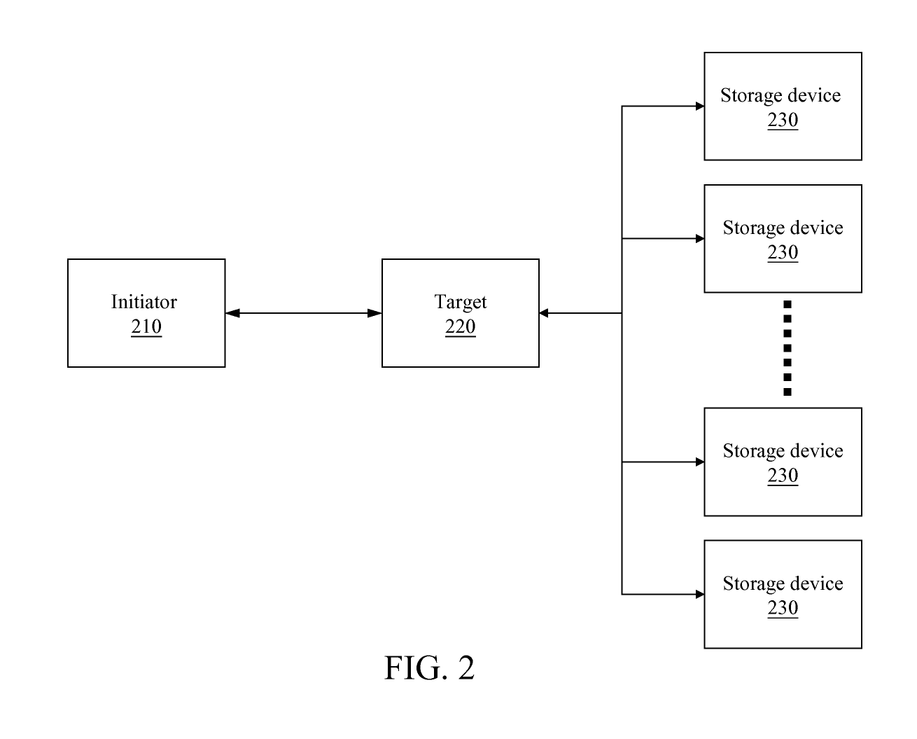

When an initiator performs a write operation on a target, the target sends out a SCSI Write CMD PDU and a Data Out PDU. The present invention provides the following operations for the Data Out PDU in order to accelerate the write operation of the target. FIG. 2 is a schematic view of an architecture of the present invention. Referring to FIG. 2, a processing system 200 of an iSCSI network packet comprises an initiator 210, a target 220, and storage devices 230.

The initiator 210 is used to send out an access request to the target 220. The initiator 210 further comprises a Host Bus Adapter (HBA) 240. The HBA 240 mainly functions to perform packet resolution on a TCP/IP packet and an iSCSI packet. The storage device 230 is used to store target information. The target 220 receives the access request from the initiator 210, accesses the target information in the storage device 230 according to the access request, and transfers the target information to the initiator 210. The target 220, the initiator 210, and the storage device 230 can transmit the SCSI Write CMD PDU or the Data Out PDU to each other through an internet, an intranet, or a cable.

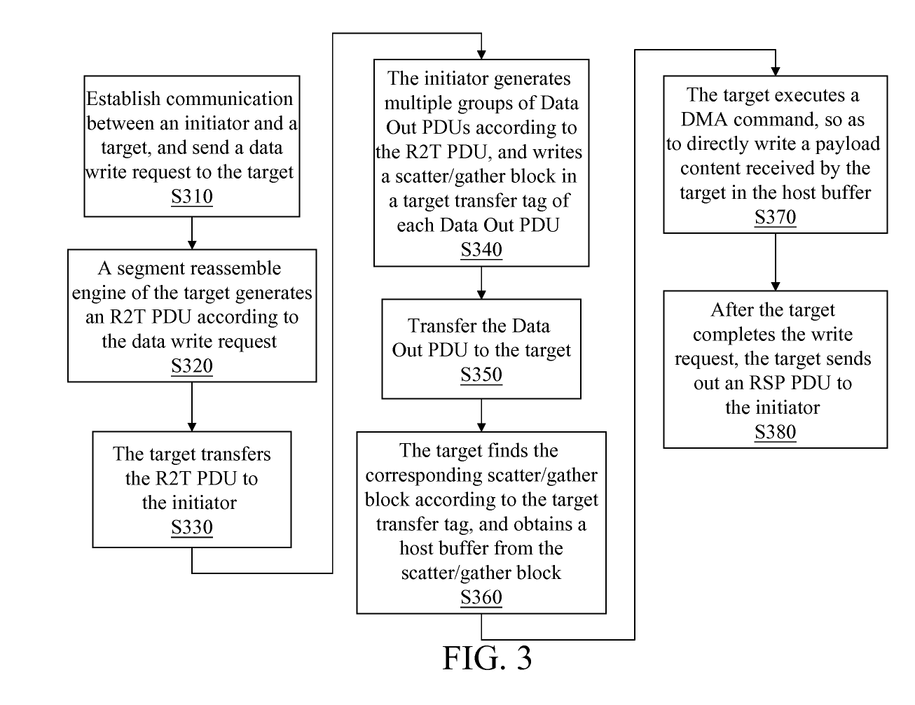

FIG. 3 is a schematic flow chart of an operation of the present invention. Referring to FIG. 3, the resolution method of the present invention comprises the following steps.

In Step S310, communication is established between an initiator and a target, and a data write request is sent to the target.

In Step S320, a segment reassemble engine of the target generates an R2T PDU according to the data write request.

In Step S330, the target transfers the R2T PDU to the initiator. In Step S340, the initiator generates multiple groups of Data Out PDUs according to the R2T PDU, and writes a scatter/gather block in a target transfer tag of each Data Out PDU.

In Step S350, the Data Out PDU is transferred to the target.

In Step S360, the target finds the corresponding scatter/gather block according to the target transfer tag, and obtains a host buffer from the scatter/gather block.

In Step S370, the target executes a DMA command, so as to directly write a payload content received by the target in the host buffer.

In Step S380, after the target completes the write request, the target sends out an RSP PDU to the initiator.

At the beginning, communication is established between the initiator and the target, so as to send the data write request to the target. Under the architecture of the iSCSI, the initiator encapsulates the data write request (SCSI Write CMD PDU) first. The data write request mainly comprises a data length to be written of the command, and allocates an Initiator Task Tag (ITT) to identify the command. In other words, whenever the initiator intends to transfer a new data sequence, the initiator sends a target transfer tag to the target, such that the target can store the new data sequence at another location, so as to avoid mixing up of different data sequences.

When the target receives the SCSI write command from the initiator, the target writes corresponding information in the target transfer tag in a header of the R2T PDU. After receiving the data write request, the target sends the R2T PDU to the initiator according to a possible size of local resources and a write length (MaxBurstLength) negotiated in login. A correspondence relation between the R2T PDU and the data write request is identified with a field of ITT 1 in the R2T PDU.

Then, the target sends the R2T PDU having the target transfer tag to the initiator. In addition, the R2T PDUs of data sequences belonging to the same group have the same target transfer tag. As one data write request may be corresponding to multiple R2T PDUs, the target differentiates different R2T PDUs in the range of the write command by using the ITT. As such, the target can determine whether an error occurs to the received R2T PDU just by checking whether the target transfer tags are the same.

The target performs modification through a driver and firmware of a network device in transfer of the R2T PDU. The driver of the target is responsible for transmitting an address of the host buffer to the firmware with a message having a format defined as follows:
sg_addr0—basic address of a scatter/gather list (sg list) of a host
sg_dma_start—index positioning of a first block of the sg list
sg_dma_len—continuous positioning number of the sg list
sg_cnt—total address length in the sg list

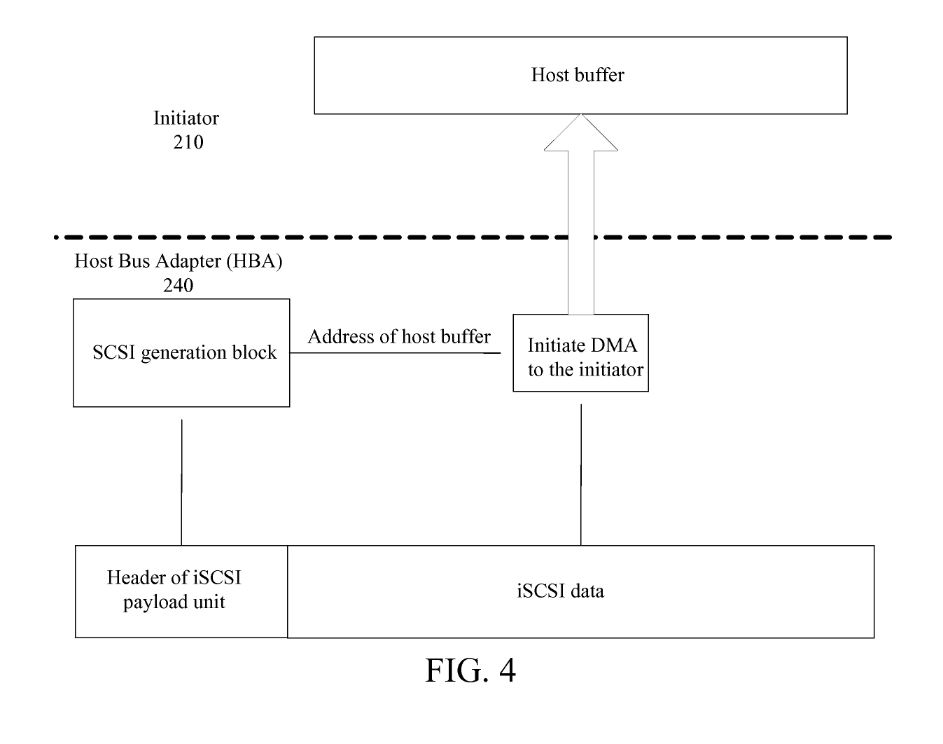

Sg_add0 records a start address of the sg list, and sg_cnt identifies the total number of the sg lists. The address of the sg list is transmitted to the firmware through sg_add0. The firmware can place the address information of these sg lists in corresponding blocks by directly accessing a memory, such that a data operation on the bottom layer can extract corresponding SCSI generation information from the blocks, and obtain data in the host by directly accessing the memory. The blocks on the firmware does not need to be allocated by the driver, and the driver only needs to know the total number of the blocks, the size of each block, and status of the blocks. Then, the driver can know the start block and the number of following blocks that should be occupied by an sg list in a next command through the current use status of the blocks, and the firmware performs processing after obtaining the information. Referring to FIG. 4, it is a schematic view of an operation for looking up an sg list in the present invention.

The buffer for storing the sg list should be allocated by the driver, and exist as iscsi_task_sg_t, and the sg list is converted to the structural form below first. In an implementation aspect of the present invention, the structure is of 12 bytes, and if the number of the st lists is known, the required space and the number of blocks required to be occupied on the firmware can be calculated.

typedef struct iscsi_task_sg_s
{

_{——}uint32_t addr_high;
_{——}uint32_t addr_low;
_{——}uint32_t len;

} iscsi_task_sg_t;

Generally, the target transfer tag is composed of a field of 32 bits. In the present invention, relevant information of the scatter/gather block to be written is further added to the target transfer tag. The target sends out a DMA command to a connected storage device, and directly writes the payload content of an iSCSI PDU in a memory address corresponding to host buffer address information. The segment reassemble engine receives the PDU from a network card and resolves it. An iSCSI layer only processes data of the payload unit in a fast path. This is because only the data of the payload unit carries data, while the data of other payload units is only for basic protocol detection. Therefore, specific resolution and error processing operations are completed by software in a slow path. When the segment reassemble engine resolves out the data of the payload unit, the segment reassemble engine extracts the location information of the iSCSI generation block from the ITT, then extracts the address information of the host buffer from the corresponding iSCSI generation block, and afterwards sends the DMA command according to the address and writes the data in the packet in the storage device connected to the target.

The present invention provides a method for analyzing a PDU of an iSCSI, so as to improve an access speed of the whole system in writing by adjusting a content of a data packet transferred by a target.

What is claimed is:

1. A method for analyzing a Protocol Data Unit (PDU) of an internet Small Computer Systems Interface (iSCSI), for processing a data write request of the iSCSI, comprising:
establishing communication between an initiator and a target, and sending the data write request to the target;
a segment reassemble engine of the target generating a Ready to Transfer (R2T) PDU according to the data write request;
the target transferring the R2T PDU to the initiator;
the initiator generating multiple groups of Data Out PDUs according to the R2T PDU, and writing a scatter/gather block in a target transfer tag of each of the Data Out PDUs;
transferring the Data Out PDU to the target;
the target finding the corresponding scatter/gather block according to the target transfer tag, and obtaining a host buffer from the scatter/gather block; and
the target executing a Direct Memory Access (DMA) command, so as to directly write a payload content received by the target in the host buffer.

2. The method for analyzing the PDU of the iSCSI according to claim 1, wherein address information of the scatter/gather block is written in the target transfer tag.

3. The method for analyzing the PDU of the iSCSI according to claim 1, wherein the target is provided with a base address register.

4. The method for analyzing the PDU of the iSCSI according to claim 3, wherein the step of writing the scatter/gather block further comprises:
writing an address offset in the target transfer tag.

5. The method for analyzing the PDU of the iSCSI according to claim 4, wherein the target positions the scatter/gather block to be assessed according to the address offset and the base address register.

6. The method for analyzing the PDU of the iSCSI according to claim 1, wherein after the target completes the write request, the target sends out an RSP PDU to the initiator.
